(19) United States
(12) Patent Application Publication
(10) Pub. No.: US 2006/0031688 A1
(43) Pub. Date: Feb. 9, 2006

(54) Power supply device for computer facility

(76) Inventor: Ching Lin Chou, Taichung (TW)

Correspondence Address: Ching Lin CHOU, P.O. Box 63-99, Taichung, 406, TW

(21) Appl. No.: 10/911,351

(22) Filed: Aug. 5, 2004

(51) Int. Cl. G06F 1/26

(52) U.S. Cl. 713/300

(57) ABSTRACT

A power supply device for coupling to a computer facility, includes a control device coupled to the power supply device and having a switch device and a coupler provided thereon and coupled together. A socket extension is coupled to the control device via the coupler, for coupling to peripheral facilities for the computer facility. The socket extension may be switched off via the switch device of the control device when the power supply device receives a switch off signal, and may be switched on via the switch device of the control device when the power supply device receives a switch on signal.

### BACKGROUND OF THE INVENTION

1. Field of the Invention

The present invention relates to a power supply device, and more particularly to a power supply device for computer facilities and for saving electric energy.

2. Description of the Prior Art

Typical power supply devices have been developed and provided for attaching to computer facilities, and for supplying electric power or energy to the computer facilities.

Normally, the computer facilities themselves comprise a switch provided therein to control the computer facilities, and to switch on and off the computer facilities.

A number of peripheral facilities, such as printers, scanners, monitors, etc. are further required to be provided and coupled to the computer facilities. However, the peripheral facilities are normally coupled to a socket extension respectively or separately, and should all be controlled or switched on and off by the other switches or control devices individually.

In addition, after the computer facilities have been switched off or terminated, the peripheral facilities may still be energized or worked, and may consume much electric power or energy. For example, if each of the peripheral facilities consumes five (5) to ten (10) watts, the at least three peripheral facilities for each computer facility may consume fifteen (15) to thirty (30) watts, and more than four hundred and fifty (450) watts may be consumed for a company having ten (10) computer facilities, such that the peripheral facilities may still consume much electric power or energy after the computer facilities have been switched off.

The present invention has arisen to mitigate and/or obviate the afore-described disadvantages of the conventional power supply devices for computer facilities.

### SUMMARY OF THE INVENTION

The primary objective of the present invention is to provide a power supply device for controlling or for switching on and off peripheral facilities for computer facilities, to switch on the peripheral facilities when the computer facilities are switched on or operated or energized, and to switch off the peripheral facilities when the computer facilities are switched off or are not operated or are not energized.

In accordance with one aspect of the invention, there is provided a power supply device for computer facility comprising a power supply device body for coupling to the computer facility, a control device coupled to the power supply device body, and including a switch device and a coupler provided thereon and coupled together, and a socket extension coupled to the control device via the coupler, for coupling to peripheral facilities. The socket extension may be switched off via the switch device of the control device when the power supply device body receives a switch off signal, and the socket extension may be switched on via the switch device of the control device when the power supply device body receives a switch on signal.

A plug may further be provided and coupled to the power supply device body, for coupling the power supply device body to a power supply. The plug may also be coupled to the control device, for coupling the control device to power supply.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram of a power supply device in accordance with the present invention;

FIG. 2 is a perspective view of a control device for the power supply device; and

FIG. 3 is a partial exploded view of the power supply device, illustrating the coupling of the control device to peripheral facilities for computer facilities.

### DETAILED DESCRIPTION OF THE PREFERRED EMBODIMENT

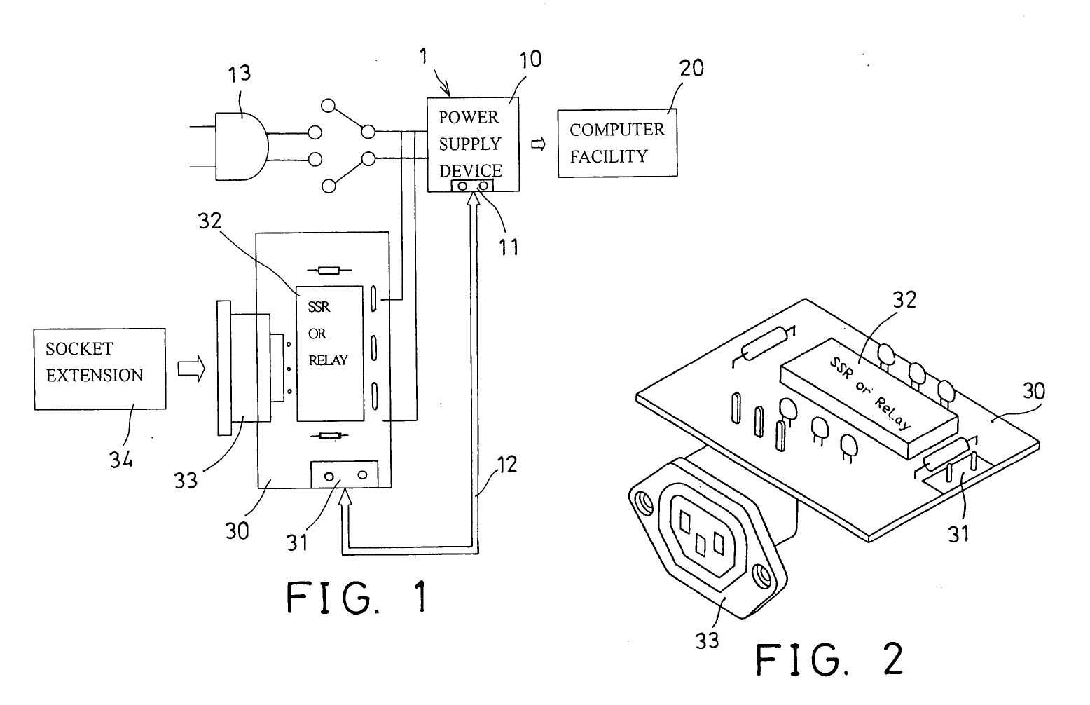

Referring to the drawings, and initially to FIGS. 1 and 2, a power supply device 1 in accordance with the present invention comprises a body 10 for attaching to or for coupling to or for being disposed in a computer facility 20, and including a terminal 11 for coupling to a corresponding terminal 31 of a control device 30 with such as cable devices 12. A coupler or a plug 13 may be coupled to the body 10 and/or the control device 30, to couple the body 10 and/or the control device 30 to electric power suppliers.

The control device 30 includes a switch device 32, such as a solid state relay or other relay, and a plug or a coupler 33 provided thereon and coupled to the switch device 32. A number of sockets or a socket extension 34 may further be provided and coupled to the control device 30 via the coupler 33, for example.

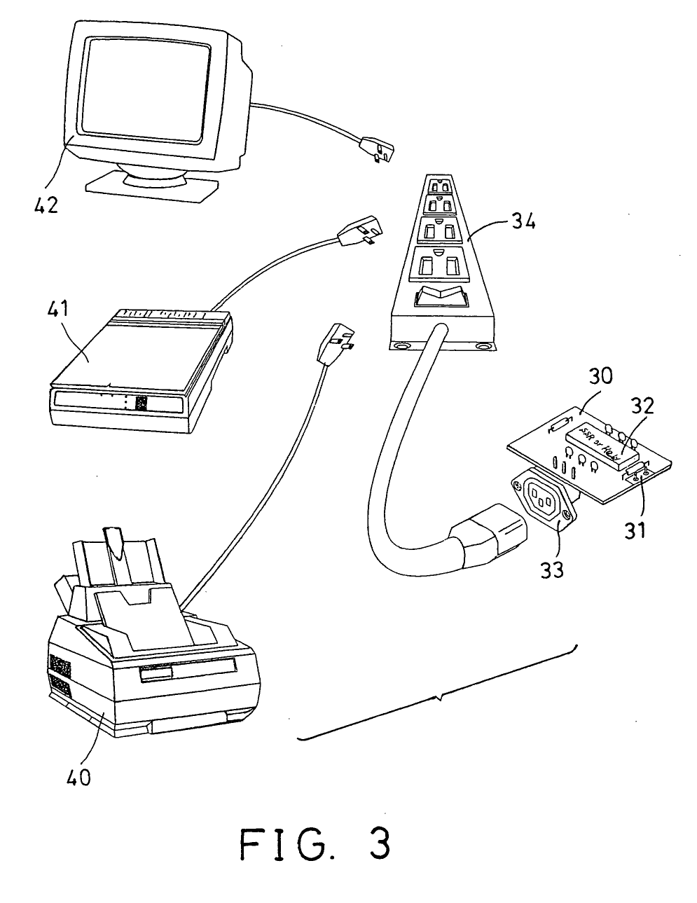

As shown in FIG. 3, various peripheral facilities 40-42, such as printers 40, scanners 41, monitors 42, etc. are further required to be provided and coupled to the computer facility 20 via the socket extension 34 and the control device 30 and the body 10 of the power supply device 1.

In operation, as shown in FIG. 1, when the computer facility 20 is switched off, a switch off signal may be sent or transmitted from the computer facility 20 to the body 10 of the power supply device 1, and then to the switch device 32 of the control device 30, in order to switch off the socket extension 34 or the peripheral facilities 40-42 simultaneously, so as to economize or safe electric energy.

On the contrary, when the computer facility 20 is switched on, a switch on signal may be sent or transmitted from the computer facility 20 to the body 10 of the power supply device 1, and then to the switch device 32 of the control device 30, in order to switch on the socket extension 34 or the peripheral facilities 40-42 simultaneously, so as to operate the peripheral facilities 40-42 only when the computer facility 20 is switched on or energized or worked.

Accordingly, the power supply device in accordance with the present invention may be used for controlling or for switching on and off peripheral facilities for computer facilities, to switch on the peripheral facilities when the computer facilities are switched on or operated or energized, and to switch off the peripheral facilities when the computer facilities are switched off or are not operated or are not energized.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A power supply device for computer facility comprising:
a power supply device body for coupling to the computer facility,
a control device coupled to said power supply device body, and including a switch device and a coupler provided thereon and coupled together, and
a socket extension coupled to said control device via said coupler, for coupling to peripheral facilities, and
said socket extension being switched off via said switch device of said control device when said power supply device body receives a switch off signal, and said socket extension being switched on via said switch device of said control device when said power supply device body receives a switch on signal.

2. The power supply device as claimed in claim 1 further comprising a plug coupled to said power supply device body, for coupling said power supply device body to a power supply.

3. The power supply device as claimed in claim 1 further comprising a plug coupled to said control device, for coupling said control device to power supply.
